(19) United States
(12) Patent Application Publication
(10) Pub. No.: US 2011/0035732 A1
(43) Pub. Date: Feb. 10, 2011

(54) Method and apparatus for defining and compiling or converting language and user interface system agnostic view definitions to runnable code

(76) Inventor: Wynne Crisman, Colorado Springs, CO (US)

Correspondence Address: DECLARATIVE ENGINEERING, LLC, 232 CUSTAR AVE., COLORADO SPRINGS, CO, 80903, US

(21) Appl. No.: 12/536,905

(22) Filed: Aug. 6, 2009

(51) Int. Cl. G06F 9/45; G06F 9/44

(52) U.S. Cl. 717/140; 717/117

(57) ABSTRACT

A method of converting a declaratively defined and language & user interface platform agnostic view to source or binary computer code that is then used to display the view at application run-time. The method includes processing of the view definition, reading the component definition for each component defined in the view, loading and executing each component builder code module to retrieve the output code for each component, and then integrating the output code for each component into a single output for the view. The method allows for new components to be introduced to the system, unknown at the time of the system's packaging, and it provides means for the view to be fully declarative in nature, including no software instructions of any kind.

### CROSS REFERENCE TO RELATED APPLICATIONS

N/A

### STATEMENT REGARDING FEDERALLY SPONSORED RESEARCH OR DEVELOPMENT

N/A

### BACKGROUND OF THE INVENTION

The present invention is generally related to how a platform agnostic view definition is converted to platform specific source or binary that is then run within an application to setup and manage the display of the view, more particularly to how the platform agnostic and declarative view component definitions are used in combination with the platform specific view component builder code modules to convert each element of the view into software runnable on a computer within the context of a calling application.

Views are an integral part of any software application. Traditionally views are developed in the same language that the rest of the application is written in such as is the case with Swing or SWT based views in Java. In recent years various “declarative” solutions to view development have appeared, such as Java Server Pages which combines HTML with inlined Java code, XAML which is either interpreted at run-time (not compiled or otherwise converted to source or binary code), or converted to a more compressed format, or Mozilla's XUL which uses a combination of XML for view layout, CSS for the display properties or view components, and Javascript for gluing or implementing functionality, and is interpreted at run-time. These solutions either combine glue code or other application logic in with the view, or require glue code to be written into the view's control logic in the application. The solutions are all rigidly language and user interface (“UI”) platform specific. This invention's view definition structure is fully declarative, includes no script or programming language code preventing mixing the presentation logic with the model or control logic. The view definition's lack of any code combined with the component definition structure makes views platform portable, meaning they can be compiled to any language supported by the components that make up the view such as, but not limited to, Java or C#, and it means that the view can be compiled to use different UI subsystems such as, but not limited to, SWT, Swing, HTML/Javascript, or WPF. Due to the view definition being converted to binary or source code preferred by the application, no run-time interpreter is required for the view definition file, and the view definition file is not even deployed with the application.

### BRIEF SUMMARY OF THE INVENTION

In accordance with the present invention, View Definition (“VD”) content is processed by a Build Process (“BP”) which doles out the processing of each component to component and platform specific Component Builder Code (“CBC”) that is either preloaded or loaded on demand. View components are defined in Component Definition (“CD”) files which are also language and user interface (“UI”) platform agnostic, and use a declarative tree based format such as Extensible Markup Language (“XML”) to define the rules for the component. The CD files reference one or more CBC modules and an entry point, one for each language and UI platform combination supported by the defined view component. The BP takes a full VD file, breaks it down into the components, loads the specific CD file for each component, determines and loads the CBC for each component, and calls that CBC's entry point to generate the output for each applicable component, finally assembling it all in to the final output.

The present invention provides a process for converting a VD file which defines how a view should look and how it should connect to the data into a runnable piece of code that will perform the actual work of displaying the view and interfacing with the data model to load and save data, and run functionality as required by the view. This system solves the problems of mixing application logic, data modeling, and view definition commonly associated with defining a view either directly in the application's language or in a pseudo language such as XUL or Javascript which may be compilable, but allow embedded code or scripts which handle the processing of events and transfer of data. This system also solves the problem of the declarative view needing to be flexible, allowing for new components unknown by the core builder code and written by third parties, by allowing third parties to define their own controls via a CD file and one or more CBC modules which are added to the development environment for an application prior to converting the VD files into source or binary output used by the application when deployed or tested. This method of defining and converting views keeps the view's language and platform agnostic while the resulting view code is in the language preferred by the application developer, with all the glue and binding code between the view and the data model being built by the CBC modules and not the developer, and no view specific interpreter necessary.

### BRIEF DESCRIPTION OF THE DRAWING

Other features and advantages of the present invention will become apparent in light of the following detailed description of the drawing, in conjunction with the drawing, of which:

FIG. 1 shows an overview of conversion process and the relationships between elements in that process.

FIG. 2 details an example of a CML file and highlights the major parts.

FIG. 3 shows an example VML file that uses the example component in FIG. 2.

### DETAILED DESCRIPTION OF THE INVENTION

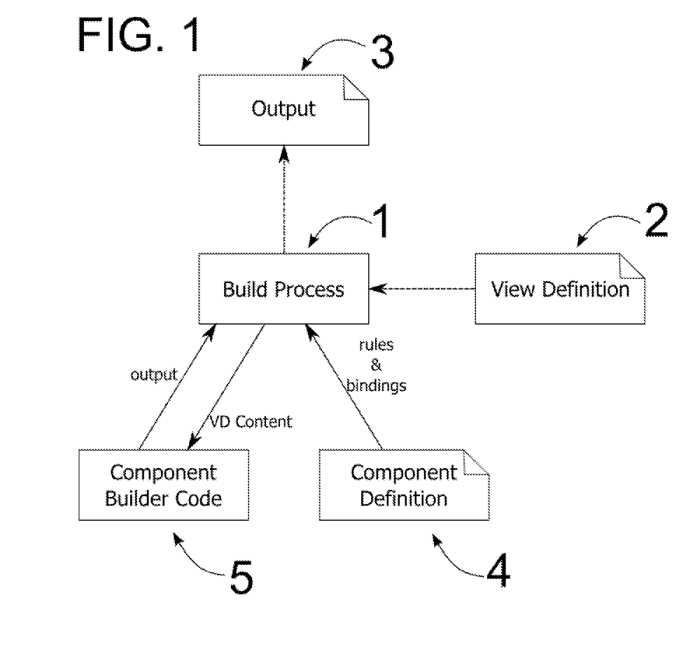

The present invention takes a platform agnostic View Definition (“VD”) file which is defined in a declarative tree format such as XML (extensible markup language), and it outputs source code or binary code that can be run by an application to instantiate and display the view. FIG. 1 shows an overview of the process by which the VD file 2 is converted into the source or binary output 3. The Central Builder (“CB”) 1 reads the VD file 2 being compiled and it breaks it down into the individual components. Each component's corresponding Component Definition (“CD”) file 4 is loaded as necessary, as well as the Component Builder Code (“CBC”) 5 for the component and the desired output platform. The BP 1 can optionally validate the portion of the VD 2 corresponding to the component being processed using the CD file 4 for the purpose of providing error feedback to the operator. The CBC 5 is then called upon to generate the output for the component, which may in turn call additional CBC's as component's in the view are often nested within each other in a tree structure. The CB 1 then puts the component outputs together into a resulting output 3 which is included with one or more applications and called upon to display and manage the view at application run-time.

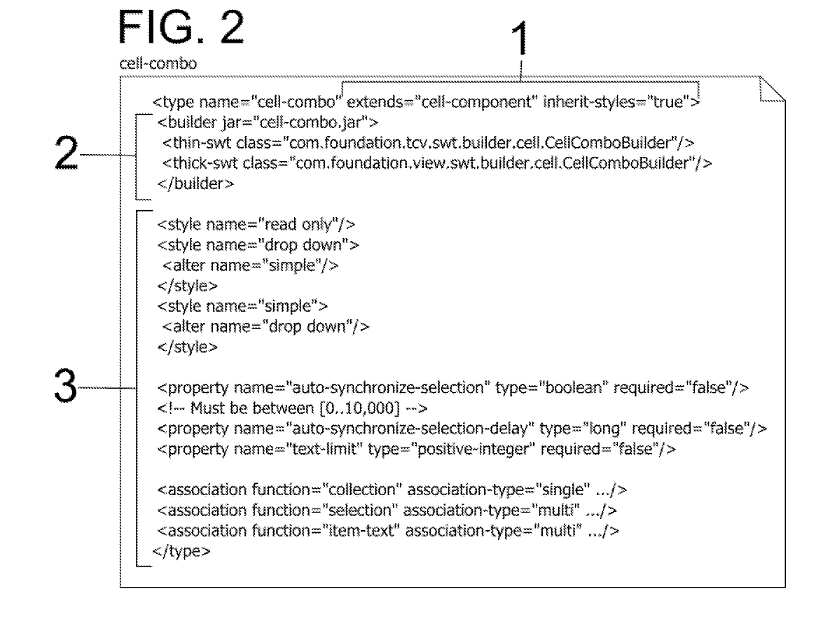

Each component has a corresponding CD file which is read as necessary by the CB. The CD file contains the rules for the component, and it defines the run-time bindings to data allowed by the component. FIG. 2 shows an example CD file for a cell-combo control. This example shows that CD files can extend other CD files 1, allowing the CD to inherit features of the extended component recursively. The CD file also defines the CBC to be used for each supported platform 2, in this case cell-combo jar is the unit of code the CBC must call upon to handle building this component, and there are two different platforms supported each with their own entry point in the code. The CD then goes on to define the structure of the data expected in the VD 3. The CD can define any combination of styles for the component, properties with fixed or default values, linkages between components, events that signal changes to the component, methods to call when the component state changes, and associations which define the relationships between the application's data model and the component's features.

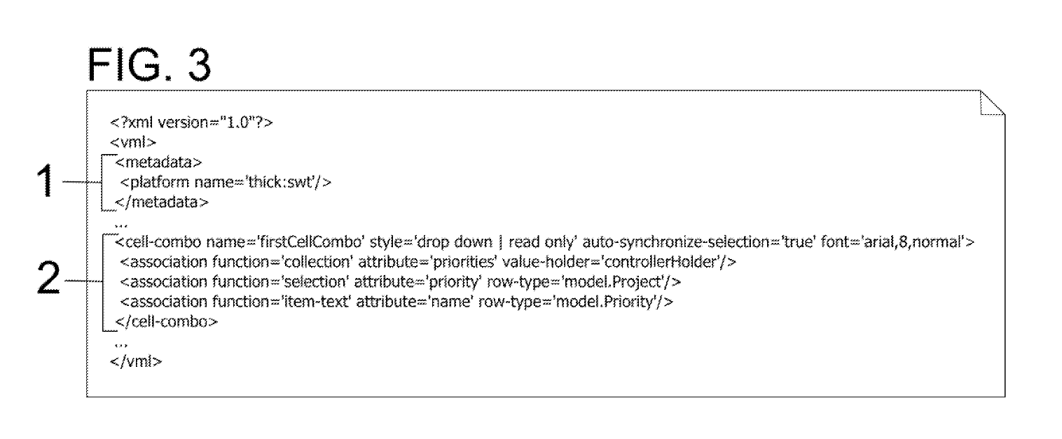

The VD file uses a declarative highly structured format for organizing the components of a view into a tree with a primary component that houses the rest of the view (such as a window or panel) along with the platform the view will target for its output. The view format its self is platform agnostic, but the components will each support their own selection of platforms that they are capable of generating output for. FIG. 3 demonstrates a VD file showing an implementation of the cell-combo component 2 defined in the CD file in FIG. 2. FIG. 3 also shows the chosen platform 1 for the VD file's output.

There is a module of code defined for each platform supported by each CD file which is responsible for generating the output for the component in the view for the specified output platform. The CBC allows the VD and CD files to remain platform agnostic, and it contains all the logic necessary for writing out the code that when run will construct the view component and link it to other components, the application's data models, and the view's control logic. What the CBC and its' output looks like is very much component and platform dependent.

What is claimed is:

1. A method for converting or compiling View Definition (“VD”) files to compilable source code or executable binary code (“the Output”) that can be integrated into a software application to produce a view or display at application run-time, comprising the steps of:
reading the VD file by the Build Process (“BP”);
identifying the components in the VD;
loading each component's Component Definition (“CD”) and optionally validating the VD's component declaration;
determining the correct Component Builder Code (“CBC”) for each component and the VD's desired output platform;
loading the CBC if it isn't already loaded for each component in the VD;
calling the entry point for each CBC and each component, passing the portion of the VD that corresponds to the component, and receiving the Output for the component;
assembling the Output for each component into a single Output for the VD file.

2. The method as defined in claim 1, wherein said VD file is defined in a declarative tree format such as XML, contains no source or binary code, is language or user interface (“UI”) platform agnostic, and is comprised of:
a reference to the platform the view's Output is targeting;
the primary component in the view;
a tree of components that extend from the primary component;
styles, properties, links, attributes, methods, events, child components, and associations between the data model or control logic in the application, that the view will interact with once converted or compiled and then run or executed, as allowed by the CD file for the component.

3. The method as defined in claim 1, wherein said CD file is defined in a declarative tree format such as XML, contains no source or binary code, is language and UI platform agnostic, and is comprised of:
a reference to the CBC and it's entry points for each platform supported by the component;
the definition of styles, properties, links, events, methods, associations between the model or control logic in the application and the component's features, and components containable by the defined component.

4. The method as defined in claim 1, wherein said CBC is a module of computer code, loadable or callable at run-time, with a defined entry point that takes at a minimum the portion of the VD file corresponding to the component being converted or compiled, and results in or outputs the Output for the component.

5. The method as defined in claim 1, wherein said BP is computer code that is run for the purpose of converting one or more VD files into source or binary computer code which is used by one or more computer software applications to create a view or display at run-time.

6. The method as defined in claim 1, wherein the CD files and CBC files are located in the development environment at the time the VD files are converted to code and are discovered by the BP as necessary to convert the components found in the VD files.
